(19) United States
(12) Patent Application Publication
(10) Pub. No.: US 2021/0050639 A1
(43) Pub. Date: Feb. 18, 2021

(54) BATTERY HOUSING FOR A FLUID TEMPERATURE-CONTROLLED BATTERY, METHOD FOR PRODUCING A BATTERY OF THIS KIND

(71) Applicant: Mahle International GmbH, Stuttgart (DE)

(72) Inventors: Ingo Haeusler, Esslingen (DE); Thomas Kalmbach, Stuttgart (DE); Christan Kern, Remseck (DE); Ruediger Knauss, Kernen i.R. (DE); Alireza Mirsadraee, Ludwigsburg (DE); Peter Nowak, Stuttgart (DE); Dennis Riegraf, Balingen (DE); Karl-Ulrich Schmid-Walderich, Tuebingen (DE); Mario Wallisch, Aichtal (DE)

(21) Appl. No.: 16/994,542

(22) Filed: Aug. 14, 2020

(30) Foreign Application Priority Data
Aug. 15, 2019 (DE) 102019212266.3

(51) Int. Cl. H01M 10/6568; H01M 10/613; H01M 10/625; H01M 2/02

(52) U.S. Cl. CPC H01M 10/6568; H01M 10/613; H01M 2220/20; H01M 2/024; H01M 10/625

(57) ABSTRACT

A battery housing for a battery, e.g., a directly fluid temperature-controllable battery of a motor vehicle, is disclosed. The battery housing includes a housing pot including a pot base and a pot collar that projects from the pot base at an angle. The housing pot delimits a housing interior, through which a dielectric temperature-control fluid can flow, for receiving one or more battery cell modules. A fluid chamber is disposed on a chamber side of the pot collar and is connected in a fluidically communicating manner to the housing interior via a plurality of apertures present in the pot collar. The fluid chamber is delimited by a chamber collar that projects outwards from the pot collar and defines a chamber opening that can be closed by a cover. At least one electrical line is arranged at least partially in the fluid chamber and passes through at least one aperture.

### CROSS-REFERENCE TO RELATED APPLICATION

This application claims priority to Germany Application No. 10 2019 212 266.3 filed Aug. 15, 2019, the contents of which are hereby incorporated by reference in its entirety.

### TECHNICAL FIELD

The invention relates to a battery housing for a fluid temperature-controllable battery and to a directly fluid temperature-controllable battery comprising a battery housing of this kind. The invention also relates to a method for producing a directly fluid temperature-controllable battery of this kind and to a motor vehicle comprising a directly fluid-temperature controllable battery of this kind.

### BACKGROUND

Batteries for storing electrical energy have been known for some time. Batteries are usually charged with electrical energy, can store this electrical energy as charge and can output this electrical energy again in a discharging process. Heat loss is generated during charging and discharging of the battery, which heat loss heats up the battery and any components present on or in the battery in a negative manner, and this can influence the functionality of the battery itself in a negative manner. Conversely, the functionality of the battery can also be affected in a negative manner if the said battery or any components present on or in it is or are too cold.

Against this background, DE 10 2017 215 609 discloses a battery housing which comprises a fluid duct structure with a plurality of fluid ducts through which a temperature-control fluid can be conducted to the battery cells of which the temperature is to be controlled. Heat transfer can take place between the temperature-control fluid and the battery cells of the battery in the process, so that heat can be discharged from the battery cells or can be supplied to the battery cells by means of the temperature-control fluid.

In order to prevent the battery cells of the battery from being short-circuited in an undesirable manner by means of the temperature-control fluid, it is customary to isolate, that is to say to electrically insulate, electrical lines for wiring the battery cells in a fluid-tight manner from the temperature-control fluid. Electrical insulation of this kind is usually accompanied by thermal insulation of the electrical lines in relation to the temperature-control fluid. This disadvantageously means that these electrical lines absorb heat which is produced during discharging or charging of the battery, but that this heat cannot be discharged or can be discharged only to an unsatisfactory extent from the electrical lines by means of the temperature-control fluid. This also applies, vice versa, to the case in which heat is intended to be supplied to the battery by means of the temperature-control fluid in order to heat up the battery to an optimum operating temperature.

Batteries usually comprise a battery housing comprising a housing pot which delimits the housing interior for receiving the battery cells. This housing pot has a pot base and a pot collar, wherein the housing pot is designed to be open at an end which is situated opposite the pot base. All components—that is to say the battery cells and also the electrical lines for wiring these battery cells—for producing the battery are inserted into the housing interior through this open end. The open end of the housing pot is then closed off in a fluid-tight manner by a housing cover.

It is considered to be disadvantageous here that all of the components of the battery can be installed in the housing interior only from one side. The consequently severely restricted installation space results in increased expenditure on installation and therefore also increased production costs for the battery.

One object of the present invention is therefore to demonstrate new approaches in respect of a battery housing and in respect of batteries with a battery housing of this kind and also in respect of methods for producing batteries of this kind and in respect of motor vehicles comprising batteries of this kind—in particular for eliminating the abovementioned disadvantages.

This object is achieved by the subject matter of the independent claim(s) and by the subjects of the coordinate claims. Preferred embodiments are the subject matter of the dependent claims.

### SUMMARY

Accordingly, the basic idea of the invention is to provide a fluid chamber on the outside of a pot collar of a housing pot of a battery housing, which fluid chamber fluidically communicates with a surrounding area which surrounds the housing to the outside via a chamber opening, and which fluid chamber at the same time fluidically communicates with a housing interior via apertures in the pot collar, which housing interior is delimited on the inside by the pot collar. This renders it possible for an electrical line for wiring at least two battery cell modules which are arranged in the housing interior and each have a plurality of battery cells to be performed through the chamber opening, wherein the electrical line passes through at least one of the apertures in the pot collar in the direction of the housing interior and is arranged at least partially in the fluid chamber.

This advantageously has the result that a temperature-control fluid which flows through the fluid chamber directly flows around or washes around the electrical line which is arranged at least partially in the fluid chamber. Therefore, the temperature of the electrical line is controlled in a particularly effective manner by means of the temperature-control fluid. Furthermore, the chamber opening and the apertures additionally form installation spaces via which wiring of the battery cell modules each having a plurality of battery cells can be performed independently of an installation space for arranging the battery cell modules in the housing interior. This considerably simplifies production of the battery comprising the battery housing.

A battery housing according to the invention which can be used for a directly fluid temperature-controllable battery has a housing pot. The battery housing for the directly fluid temperature-controllable battery can expediently be used for a motor vehicle. The housing pot comprises a pot base and a pot collar which projects from the pot base at an angle. The housing pot delimits a housing interior for receiving a plurality of battery cell modules each having a plurality of battery cells of the battery, wherein a temperature-control fluid can flow through the housing interior. In the process, the temperature-control fluid directly flows around the battery cell modules which are arranged in the housing interior, so that unobstructed—that is to say direct—heat transfer can take place between the temperature-control fluid and the battery cells or the battery cell modules. In the process, the battery cells of the battery modules come into direct contact with the temperature-control fluid. There is a fluid chamber on a chamber side of the pot collar that is averted from the housing interior. The fluid chamber is connected in a fluidically communicating manner to the housing interior via a plurality of apertures which are present in the pot collar. The pot collar therefore forms a base of the fluid chamber. The fluid chamber is also delimited by a chamber collar which projects outwards from the pot collar. The chamber collar is expediently integrally formed on the pot collar. This means that the pot collar and the chamber collar are preferably designed in one piece and with the same material. The chamber collar also borders a chamber opening which can be closed off or is closed off in a fluid-tight manner by means of a cover. At least one electrical line for electrically wiring at least two of the battery cell modules can be installed through the chamber opening in such a way that the temperature-control fluid can flow around the electrical line. To this end, the electrical line can be installed in such a way that it is arranged at least partially in the fluid chamber and passes through at least one of the apertures which is provided in the pot collar. The electrical line expediently passes through two of these apertures. Therefore, the temperature of the electrical line can advantageously be controlled in a particularly effective manner by means of the temperature-control fluid which flows around the said electrical line. Furthermore, the chamber opening and the apertures form an additional installation access through which the electrical line can be inserted and installed for wiring the battery cell modules. This allows considerably increased flexibility when producing a fluid temperature-controllable battery comprising the battery housing, this being accompanied by savings in time and therefore advantages in respect of cost.

The cover for closing off the chamber opening in a fluid-tight manner from an outer surrounding area of the battery housing expediently can be fitted or is fitted to the chamber collar. A cover which is embodied in this way can be fitted in a particularly simple manner, this having a direct effect on the expenditure on production of the battery housing and, respectively, of the battery comprising the battery housing in an advantageous manner.

In an advantageous development of the battery housing, a projection is provided on an inner side of the cover, which inner side faces the housing interior, which projection forms a positioning aid. This projection is matched to the chamber opening in such a way that the projection of the cover can be received or is received in the chamber opening. The chamber opening and the projection of the cover are expediently matched to one another with an accurate fit. Therefore, the cover can advantageously be positioned particularly exactly on the chamber opening, this allowing the chamber opening to be closed off in a particularly reliable fluid-tight manner by means of the cover.

According to a further advantageous development of the battery housing, there is an encircling recess which is matched to the chamber collar on the inner side of the cover, which inner side faces the housing interior. This encircling recess is expediently designed in a groove-like manner. The chamber collar can be at least partially received or is at least partially received in the recess. The chamber collar and the recess are expediently matched to one another in such a way that the chamber collar can be received or is received in the recess with an accurate fit. As a result, even more exact positioning of the cover on the chamber collar can advantageously be achieved. Furthermore, this development is advantageous in respect of closing off the chamber opening in a fluid-tight manner by means of the cover.

Expediently, the cover can be fastened or is fastened to the chamber collar by means of a screw connection. A screw connection of this kind advantageously allows the cover to be fastened to the chamber collar in a reliable and detachable manner.

In a further advantageous development, the cover can be connected or is connected to the chamber collar in a cohesive manner. Expediently, the cover can be adhesively bonded or is adhesively bonded or can be welded or is welded to the chamber collar. A cohesive connection of this kind of the cover to the chamber collar renders possible particularly cost-effective connection of the cover to the chamber collar. Furthermore, cohesive connections of this kind are advantageously particularly fluid-tight, this also being advantageous in respect of closing off the chamber opening in a fluid-tight manner by means of the cover.

According to a further advantageous development, a sealing element is provided between the cover and the chamber collar for closing off the chamber opening in a fluid-tight manner. Expediently, this sealing element can be fastened or is fastened to the cover and/or to the chamber collar. A sealing element of this kind advantageously allows the chamber opening to be particularly reliably closed off in a fluid-tight manner by means of the cover.

The sealing element is expediently arranged in the encircling recess of the cover. Therefore, correct positioning of the sealing element between the cover and the chamber collar can advantageously be ensured in a particularly simple manner.

A further advantageous development of the battery housing makes provision for the encircling recess of the cover to form a casting shell. An adhesive compound or a sealing compound can be received or is received in the recess, which forms a casting shell, for closing off the chamber opening in a fluid-tight manner by means of the cover. In the process, the adhesive compound or sealing compound is received in the recess in such a way that the cover can be connected or is connected to the chamber collar in a fluid-tight manner by means of the adhesive compound or sealing compound which is received in the recess. This advantageously results in firstly the positioning of the cover relative to the chamber opening being made more precise by means of the recess by way of the chamber collar being received in the recess, and at the same time metering of the adhesive compound or sealing compound and the distribution thereof over the joining areas being improved at the same time.

According to a further preferred development, there is a reinforcement on the chamber collar and/or on the pot collar for bracing the fluid chamber in a region of the chamber opening and/or at least one of the apertures. Bracing of this kind of the fluid chamber advantageously improves the mechanical resistance of those parts of the battery housing that delimit the fluid chamber.

The cover is expediently designed with reinforcements which preferably protrude into the chamber opening. The reinforcements which are arranged on the cover are particularly preferably supported on the pot collar and/or the chamber collar. A resulting advantage is that the cover which is braced by means of the reinforcements is subject to particularly little deformation when it is fitted. Furthermore, the reinforcements of the cover and the reinforcements of the pot collar or of the chamber collar can advantageously be matched to one another such that the respective reinforcements engage one in the other and therefore increase the bracing action of each other.

The chamber opening and at least one of the apertures are expediently arranged such that the electrical line can be installed through the chamber opening. All of the apertures are preferably arranged relative to the chamber opening such that the electrical line can be installed through the chamber opening. The electrical line can particularly expediently be installed through the chamber opening without obstruction. This advantageously renders possible particularly simple installation of the electrical line for wiring the battery cell modules which are arranged in the housing interior.

The invention also relates to a, preferably directly fluid temperature-controllable, battery which is suitable for use in a motor vehicle. The battery has a plurality of battery cell modules each having a plurality of battery cells, which battery cell modules are received in a housing interior which is delimited by a battery housing according to the preceding description. The battery cell modules are electrically wired to one another by means of electrical lines. At least one of the electrical lines is arranged at least partially in the fluid chamber of the battery housing and passes through at least one aperture which is provided in the pot collar of the battery housing. The electrical line expediently passes through two of the apertures in the pot collar. The advantages demonstrated above of the battery housing according to the invention can be transferred in an analogous manner to the directly fluid temperature-controllable battery according to the invention too.

An advantageous development of the directly fluid temperature-controllable battery makes provision for at least one of the electrical lines to be arranged in a substantially U-shaped manner. The electrical line which is arranged in a substantially U-shaped manner has two open ends and a closed end which is situated opposite these open ends. In each case one of the open ends of the lines passes through in each case one aperture in the pot collar, wherein the closed end is arranged in the fluid chamber. Here, in each case one of the open ends is electrically connected to in each case one battery cell module which is arranged in the housing interior. Lines of this kind which are arranged in a U-shaped manner can advantageously be designed as U-shaped conductor elements which can be standardized and which can be produced on a large scale, as a result of which advantages in respect of cost are created when producing electrical lines of this kind by way of utilizing economies of scale.

Furthermore, the invention relates to a method for producing a directly fluid temperature-controllable battery in accordance with the above description. According to the invention, this method comprises six measures a) to f). According to a first measure a), a battery housing according to the invention as described above is provided. A second measure b) makes provision for at least one battery cell module to be arranged in the housing interior of the battery housing which is provided in measure a). In measure b), a plurality of battery cell modules are expediently arranged in the housing interior of the battery housing. In a further measure c), at least one electrical line is guided through the chamber opening of the fluid chamber of the battery housing. According to a further measure d), the electrical line is arranged in such a way that it passes through at least one aperture of the battery housing, expediently two apertures of the battery housing. In a further measure e), at least one of the battery cell modules is electrically connected to the electrical line. According to measure e), the electrical line is preferably connected to two battery cell modules. This means that the two battery cell modules can be electrically connected to one another by means of the electrical line. A last measure f) involves closing off the chamber opening in a fluid-tight manner by means of the cover of the battery housing, as a result of which the directly fluid temperature-controllable battery is formed. The advantages demonstrated above of the battery housing according to the invention and of the battery according to the invention comprising a battery housing of this kind can be transferred in an analogous manner to the method according to the invention for producing a directly fluid temperature-controllable battery of this kind too.

The invention further relates to a motor vehicle which comprises a directly fluid temperature-controllable battery according to the invention as described above. This directly fluid temperature-controllable battery is expediently produced by means of a method according to the invention for producing a directly fluid temperature-controllable battery of this kind according to the above description. The motor vehicle also comprises an electrical machine which is electrically connected to the directly fluid temperature-controllable battery. The advantages demonstrated above of the battery housing according to the invention and of the battery according to the invention comprising a battery housing of this kind and those of the method according to the invention for producing a fluid temperature-controllable battery of this kind can be transferred in an analogous manner to the motor vehicle comprising a directly fluid temperature-controllable battery of this kind too.

Further important features and advantages of the invention can be gathered from the dependent claims, from the drawings and from the associated description of the figures with reference to the drawings.

It goes without saying that the features mentioned above and those still to be explained below can be used not only in the respectively indicated combination but also in other combinations or on their own, without departing from the scope of the present invention.

Preferred exemplary embodiments of the invention are illustrated in the drawings and will be explained in more detail in the following description, where identical reference signs refer to identical or similar or functionally identical components.

### BRIEF DESCRIPTION OF THE DRAWINGS

In the drawings, in each case schematically;

FIG. 1 shows, by way of example, a side view of a directly fluid temperature-controllable battery according to the invention using an example of a battery housing according to the invention,

FIG. 2 shows a perspective illustration of the directly fluid temperature-controllable battery comprising the battery housing of FIG. 1,

FIG. 3 shows a first example of a cover for a chamber opening of a battery housing according to the invention,

FIG. 4 shows a second example of a cover of the chamber opening of a battery housing according to the invention,

FIG. 5 shows, in a highly schematic manner, a partial illustration of a section through the battery of FIGS. 1 and 2 parallel to a pot base of the battery housing of the battery,

FIG. 6 shows, by way of example, a flow chart which illustrates the method according to the invention for producing a directly fluid temperature-controllable battery according to the invention.

### DETAILED DESCRIPTION

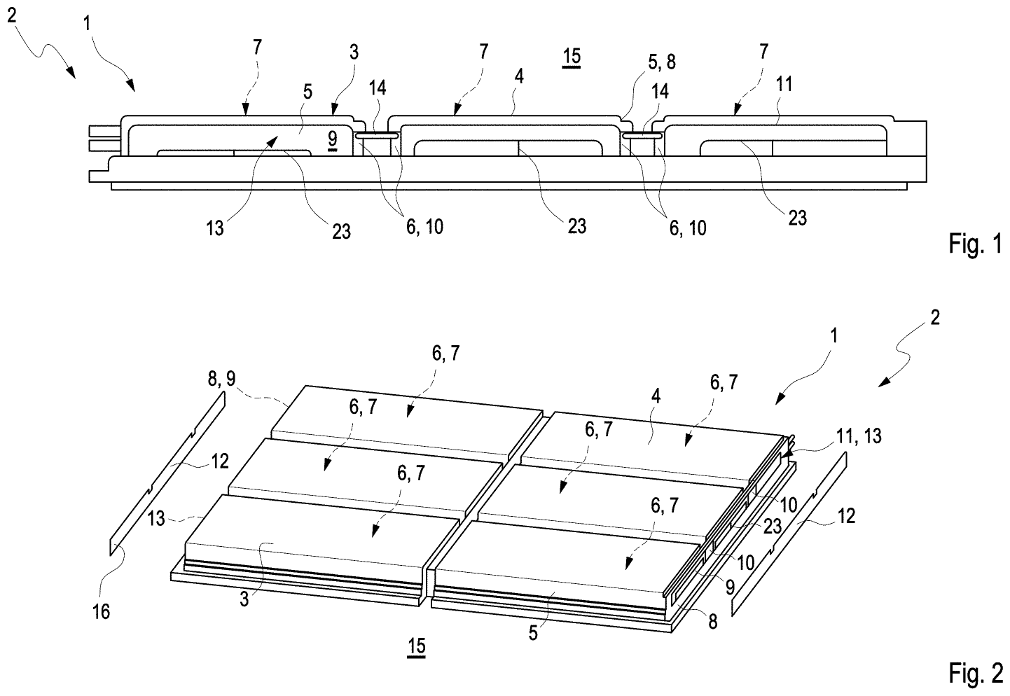

FIG. 1 shows a side view of an example of a directly fluid temperature-controllable battery according to the invention which comprises a battery housing 1 which is likewise shown by way of example in FIG. 1. The directly fluid temperature-controllable battery 2 comprising the battery housing 1 is suitable for use in a motor vehicle. The battery housing 1 has a housing pot 3 which delimits a housing interior 6 for receiving a plurality of battery cell modules 7 each having a plurality of battery cells of the battery 2. A temperature-control fluid can flow through the housing interior 6 which is delimited by the housing pot 3. The temperature-control fluid controls the temperature of the battery cell modules 7 of the battery 2—that is to say absorbs heat or outputs heat for this purpose—by means of direct contact with the said battery cell modules.

The housing pot 3 has a pot base 4. A pot collar 5 of the housing pot 3 projects from the pot base 4 of the housing pot 3 at an angle. The battery housing 1 comprises a fluid chamber 9 on a chamber side 8 of the pot collar 5 that is averted from the housing interior 6. The fluid chamber 9 which is arranged on the outside of the chamber side 8 of the pot collar 5 is connected in a fluidically communicating manner to the housing interior 6 via a plurality of apertures 10 which are present in the pot collar 5. In this case, the pot collar 5 forms a base of the fluid chamber 9. The fluid chamber 9 is also delimited by a chamber collar 11 which projects outwards from the pot collar 5. The chamber collar 11 can be integrally formed on the pot collar 5. This means that the pot collar 5 and the chamber collar 11 can be designed in one piece and/or with the same material. The chamber collar 11 also bounds a chamber opening 13. This means that the chamber collar 11 borders and delimits the chamber opening 13. The chamber opening 13 of the fluid chamber 9 can be closed in a fluid-tight manner by means of a cover 12—not shown in FIG. 1. At least one electrical line 14 for electrically wiring at least two of the battery cell modules 7 can be installed through the chamber opening 13 in such a way that the temperature-control fluid can flow around the electrical line 14. In this case, the electrical line 14 can be installed such that the electrical line 14 is arranged at least partially in the fluid chamber 9 and passes through at least one aperture 10 in the pot collar 5.

As can be seen in FIG. 1, the electrical line 14 can pass through two of the apertures 10. There can be a reinforcement 23 on the chamber collar 11 and/or the pot collar 5 in the fluid chamber 9 in a region of the chamber opening 3 and/or in a region of at least one of the apertures 10 in the pot collar 5 for bracing the fluid chamber 9. In this case, the reinforcement 23 can be present both on the pot collar 5 and on the chamber collar 11. The reinforcement 23 can be integrally formed on the chamber collar 11 and/or on the pot collar 5. This means that the reinforcement 23 can be formed in one piece with the pot collar and/or with the chamber collar 11. It should likewise be understood here that the reinforcement 23 can be embodied from the same material as the chamber collar 11 and/or the pot collar 5. The reinforcement 23 can be of rib-like design. It can also be seen that the chamber opening 13 and at least one of the apertures 10 are arranged relative to one another such that the electrical line 14 can be installed through the chamber opening 13. The chamber opening 13 can be arranged relative to all of the apertures 10—four apertures 10 of this kind are shown in FIG. 1—such that the at least one electrical line 14 can be installed through the chamber opening 13. In the example of FIG. 1, the electrical line 14 can be installed through the chamber opening 13 without obstruction. As an alternative or in addition, the cover 12—which is not shown in the figures—can likewise be formed with reinforcements 23. The reinforcements 23 which are arranged on the cover 12 can protrude into the chamber opening 13 and can be supported on the pot collar 5 and/or the chamber collar 11. The reinforcements 23 of the cover 12 and the reinforcements 23 of the pot collar 5 or of the chamber collar 11 can engage one in the other and increase the bracing action of each other.

FIG. 2 shows a perspective illustration of the directly fluid temperature-controllable battery 2 comprising the battery housing 1 of FIG. 1. It can be seen that the cover 12 for closing off the chamber opening 13 in a fluid-tight manner from an outer surrounding area 15 of the battery housing 1 can be fitted on the chamber collar 11. The cover 12 can be fastened to the chamber collar 11 by means of a screw connection. However, this is not shown in the figures. The cover 12 can be connected to the chamber collar 11 in a cohesive manner. For cohesively connecting the cover 12 to the chamber collar 11, the cover 12 can be adhesively bonded or welded to the chamber collar 11.

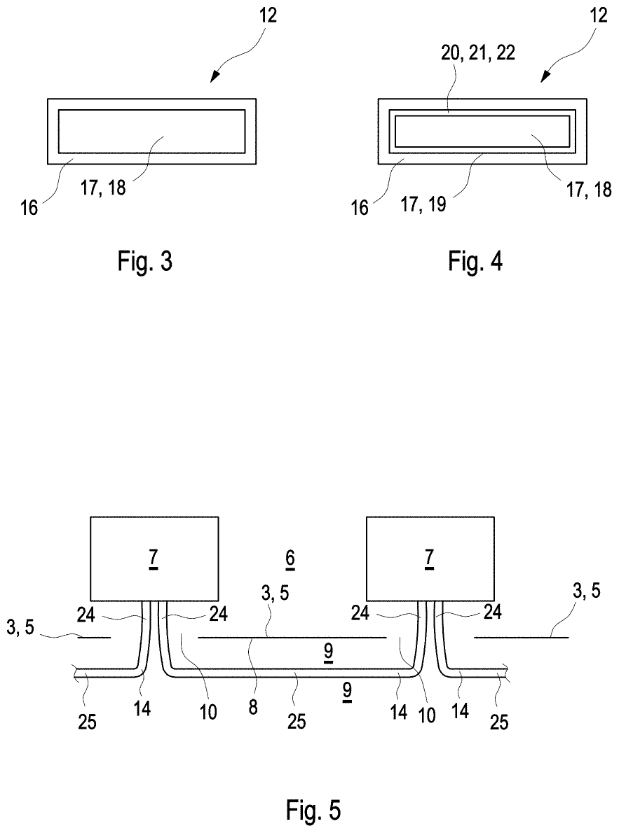

A first example of this cover 12 is shown in a plan view of an inner side 16 of the cover 12 in FIG. 3. The inner side 16 of the cover 12 can face the housing interior 6 of the battery housing 1 in a fitted state of the cover 12 in which said cover closes the chamber opening 13 in a fluid-tight manner. A projection 18 can be formed on the inner side 16 of the cover 12 for forming a positioning aid 17. The projection 18 which forms the positioning aid 17 can be matched to the chamber opening 13 in such a way that the projection 18 of the cover 12 can be received in the chamber opening 13. To this end, the projection 18 and the chamber opening 13 can be matched to one another with an accurate fit.

FIG. 4 shows a further example of the cover 12 for a battery housing 1 according to the invention likewise in a plan view of the inner side 16 of the cover 12. Accordingly, there can be an encircling recess 19 on the inner side 16 of the cover 12, which recess is matched to the chamber collar 11. The recess 19 can be designed in a groove-like manner. The chamber collar 11 and the recess 19 can be matched to one another in such a way that the chamber collar 11 can be received at least partially by the recess 19. To this end, the recess 19 and the chamber collar 11 are matched to one another with an accurate fit. In this case, a sealing element 20 can be provided between the cover 12 and the chamber collar 11 for closing off the chamber opening 13 in a fluid-tight manner. This sealing element 20 can be fastened to the chamber collar 11 or—as shown in FIG. 4—fastened to the cover 12. Accordingly, the sealing element 20 can be arranged in the encircling recess 19 of the cover 12. As an alternative or in addition, the encircling recess 19 of the cover 12 can also form a casting shell in which an adhesive compound 21 or a sealing compound 22 can be accommodated for closing off the chamber opening 13 in a fluid-tight manner by means of the cover 12. This means that the adhesive compound 21 or the sealing compound 22 can be poured into the recess 19 which forms a casting shell, and the cover 12 can then be connected in a fluid-tight manner to the chamber collar 11 by means of the adhesive compound 21 or sealing compound 22 which is located in the recess 19. The chamber collar 11 can likewise be received in the recess 19 of the cover 12 in this case.

FIG. 5 shows a highly schematic partial view of a section through the directly fluid temperature-controllable battery 2 of FIG. 2 parallel to the pot base 4 of the battery housing 1 of the directly fluid temperature-controllable battery 2. It can be seen that a plurality of battery cell modules 7 are received in the housing interior 6, which is delimited by the battery housing 1, according to the invention. The plurality of battery cell modules 7 are electrically wired to one another by means of electrical line 14. In this case, at least one electrical line 14 is arranged at least partially in the fluid chamber 9 of the battery housing 1. This at least one electrical line 14 also passes through at least one of the apertures 10 in the pot collar 5 of the battery housing 1. The at least one electrical line 14 can also pass through two apertures 10, as is shown in FIG. 5. The at least one electrical line 14 can be arranged in a substantially U-shaped manner. The electrical line 14 which is arranged in a substantially U-shaped manner can have two open ends 24 and a closed end 25, wherein the closed end 25 is situated opposite the two open ends 24. In each case one of the open ends 24 of the line 14 can pass through in each case one aperture 10. The closed end 25 can be arranged in the fluid chamber 9. In each case one of the open ends 24 can be electrically connected to in each case one battery cell module 7 which is arranged in the housing interior 6.

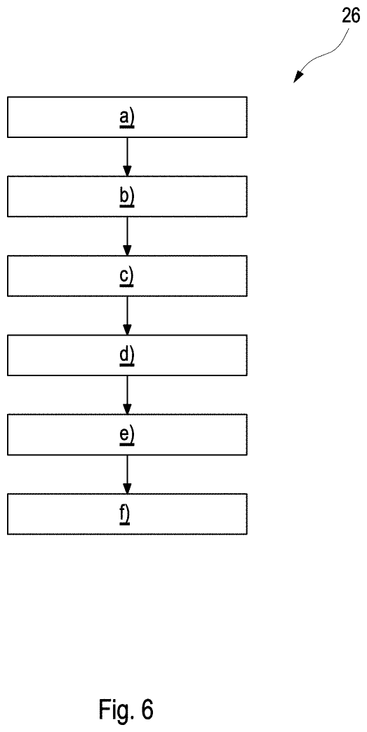

Furthermore. FIG. 6 illustrates, by way of example, a method 26 according to the invention for producing a directly fluid temperature-controllable battery 2, as already described above, using a flow chart. Accordingly, the method 26 comprises six measures a) to f) which can be implemented in the order demonstrated in FIG. 6. However, it goes without saying that other orders of measures a) to f) are also conceivable, without departing from the scope of the invention. Similarly, various measures from amongst measures a) to f) can be combined and carried out in one working step in each case. A first measure a) involves providing a battery housing 1 according to the invention in accordance with the above description. A second measure b) makes provision for at least one battery cell module 7 to be arranged in the housing interior 6 of the battery housing 1. According to measure b), a plurality of battery cell modules 7 of this kind can also be arranged in the housing interior 6 of the battery housing 1. A further measure c) makes provision for at least one electrical line 14 to be guided through the chamber opening 13 of the fluid chamber 9 of the battery housing 1. In a further measure d), the electrical line 14 is arranged such that it passes through at least one of the apertures 10 of the battery housing 1. In this case, the electrical line 14 can be arranged such that it passes through two apertures 10 of the battery housing 1. In a further measure e), at least one of the battery cell modules 7 is electrically connected to the electrical line 14. According to measure e), two of the battery cell modules 7 can also each be connected to the electrical line 14, so that the two battery cell modules 7 are connected to one another by means of the electrical line 14. A last measure f) involves closing off the chamber opening 13 in a fluid-tight manner by means of the cover 12 of the battery housing 1. The directly fluid temperature-controllable battery 2 is formed as a result of implementing measure f).

The invention also relates to a motor vehicle which comprises a directly fluid temperature-controllable battery 2 as described above, wherein the fluid temperature-controllable battery 2 can be produced by means of the above-described method 26. The motor vehicle also has an electrical machine which is electrically connected to the directly fluid temperature-controllable battery 2.

1. A battery housing for a battery, comprising:
a housing pot including a pot base and a pot collar which projects from the pot base at an angle, wherein the housing pot delimits a housing interior, through which a dielectric temperature-control fluid can flow, for receiving a plurality of battery cell modules each having a plurality of battery cells of the battery;
a fluid chamber disposed on a chamber side of the pot collar that is averted from the housing interior, the fluid chamber connected in a fluidically communicating manner to the housing interior via a plurality of apertures that are present in the pot collar;
wherein the fluid chamber is delimited by a chamber collar that projects outwards from the pot collar, the chamber collar delimits a chamber opening that can be closed in a fluid-tight manner via a cover; and
at least one electrical line for electrically wiring at least two of the battery cell modules installed through the chamber opening such that the at least one electrical line is arranged at least partially in the fluid chamber such that a temperature-control fluid can flow around the at least one electrical line, and the at least one electrical line passes through at least one aperture of the plurality of apertures.

2. The battery housing according to claim 1, wherein the cover closes off the chamber opening in a fluid-tight manner from an outer surrounding area and is fitted on the chamber collar.

3. The battery housing according to claim 1, further comprising a projection disposed on an inner side of the cover that faces towards the housing interior for forming a positioning aid, wherein the projection is matched to the chamber opening such that the projection of the cover is received in the chamber opening.

4. The battery housing according to claim 1, further comprising an encircling recess that is matched to the chamber collar on an inner side of the cover that faces towards the housing interior, wherein the chamber collar is at least partially received in the encircling recess.

5. The battery housing according to claim 1, wherein the cover is fastened to the chamber collar via a screw connection.

6. The battery housing according to claim 1, wherein the cover is connected to the chamber collar in a cohesive manner.

7. The battery housing according to claim 1, further comprising a sealing element is provided between the cover and the chamber collar for closing off the chamber opening in a fluid-tight manner, wherein the sealing element can be fastened to at least one of the cover and the chamber collar.

8. The battery housing according to claim 7, wherein the sealing element is arranged in an encircling recess of the cover.

9. The battery housing according to claim 8, wherein the encircling recess of the cover provides a casting shell in which an adhesive compound or a sealing compound can be received for closing off the chamber opening in a fluid-tight manner via the cover, so that the cover can be connected in a fluid-tight manner to the chamber collar via the adhesive compound or the sealing compound that is received in the recess.

10. The battery housing according to claim 1, further comprising a reinforcement disposed on at least one of the chamber collar, the pot collar, and the cover for bracing the fluid chamber in a region of at least one of the chamber opening and the at least one aperture.

11. The battery housing according to claim 1, wherein the chamber opening and the at least one aperture are arranged such that the at least one electrical line can be installed through the chamber opening.

12. A directly fluid temperature-controllable battery, comprising:
a plurality of battery cell modules electrically wired to one another via electrical lines and received in a housing interior that is delimited by a battery housing, the battery housing including:
a cover;
a housing pot including a pot base and a pot collar that projects from the pot base at an angle;
a fluid chamber disposed on a chamber side of the pot collar that is averted from the housing interior, the fluid chamber connected in a fluidically communicating manner to the housing interior via a plurality of apertures that are present in the pot collar;
wherein the fluid chamber is delimited by a chamber collar that projects outwards from the pot collar, the chamber collar delimiting a chamber opening that is closed in a fluid-tight manner via the cover;
wherein at least one of the electrical lines is arranged at least partially in the fluid chamber of the battery housing and passes through at least one of the plurality of apertures in the pot collar of the battery housing.

13. The directly fluid temperature-controllable battery according to claim 12, wherein:
at least one of the electrical lines is arranged in a substantially U-shaped manner and has two open ends and a closed end that is situated opposite to the two open ends,
each one of the two open ends of the at least one electrical line passes through a respective one of the plurality of apertures, and the closed end is arranged in the fluid chamber, and
one of the two open ends is electrically connected to a respective one of the plurality of battery cell modules arranged in the housing interior.

14. A method for producing a battery, comprising:
a) providing a battery housing;
b) arranging at least one battery cell module in a housing interior of the battery housing;
c) guiding at least one electrical line through a chamber opening of a fluid chamber of the battery housing;
d) arranging the at least one electrical line, so that it passes through at least one aperture of the battery housing;
e) electrically connecting the at least one battery cell module to the at least one electrical line; and
f) closing off the chamber opening in a fluid-tight manner via a cover of the battery housing to form a directly fluid temperature-controllable battery.

15. A motor vehicle comprising a directly fluid temperature-controllable battery according to claim 12; and
further comprising an electrical machine electrically connected to the directly fluid temperature-controllable battery.

16. The directly fluid temperature-controllable battery according to claim 12, wherein the cover closes off the chamber opening in a fluid-tight manner from an outer surrounding area of the battery housing and is fitted on the chamber collar.

17. The directly fluid temperature-controllable battery according to claim 12, further comprising an encircling groove-like recess that is matched to the chamber collar on an inner side of the cover that faces towards the housing interior, wherein the chamber collar is at least partially received in the encircling groove-like recess.

18. The directly fluid temperature-controllable battery according to claim 12, wherein the cover is fastened to the chamber collar via a screw connection.

19. The directly fluid temperature-controllable battery according to claim 12, wherein the cover is adhesively bonded or welded to the chamber collar.

20. The directly fluid temperature-controllable battery according to claim 12, further comprising a sealing element provided between the cover and the chamber collar for closing off the chamber opening in a fluid-tight manner.
